(19) United States
(12) Patent Application Publication
(10) Pub. No.: US 2025/0174651 A1
(43) Pub. Date: May 29, 2025

(54) NON-AQUEOUS ELECTROLYTE SECONDARY BATTERY AND METHOD OF MANUFACTURING SAME

(71) Applicant: Prime Planet Energy & Solutions, Inc., Tokyo (JP)

(72) Inventor: Hikaru YOSHIDA, Ibaraki-shi (JP)

(21) Appl. No.: 18/963,524

(22) Filed: Nov. 28, 2024

(30) Foreign Application Priority Data
Nov. 29, 2023 (JP) 2023-201548

(51) Int. Cl. H01M 4/525; H01M 4/02; H01M 4/587; H01M 10/04; H01M 50/609

(52) U.S. Cl. CPC H01M 4/525; H01M 4/587; H01M 10/049; H01M 50/609; H01M 2004/021

(57) ABSTRACT

The present disclosure relates to a non-aqueous electrolyte secondary battery, wherein a positive electrode active material layer includes a positive electrode active material represented by a formula (1), and when a specific surface area of a negative electrode active material layer is represented by S, an average boron content of boron in the negative electrode active material layer is represented by M1 (mass %), and a boron content in a central portion of the negative electrode active material layer is represented by M2 (mass %), (a) M1/S≤0.1 and (b) M2≥0.05 are satisfied.

### CROSS REFERENCE TO RELATED APPLICATIONS

This nonprovisional application is based on Japanese Patent Application No. 2023-201548 filed on Nov. 29, 2023 with the Japan Patent Office, the entire contents of which are hereby incorporated by reference.

### BACKGROUND OF THE INVENTION

### Field of the Invention

The present disclosure relates to a non-aqueous electrolyte secondary battery, and also relates to a method of manufacturing the non-aqueous electrolyte secondary battery.

### Description of the Background Art

Japanese Patent Laying-Open No. 2022-112207 proposes a non-aqueous electrolyte secondary battery in which a lithium composite oxide having a high nickel content is used for a positive electrode active material layer.

### SUMMARY OF THE INVENTION

When the lithium composite oxide having a high nickel content is used for the positive electrode active material layer, the non-aqueous electrolyte secondary battery (hereinafter also referred to as “battery”) can have a high capacity. However, it has been found that when an electrically conductive foreign matter is introduced into the battery, heat of reaction between the positive electrode plate and an electrolyte solution tends to be likely to be generated due to the following steps (1) to (3).
(1) A current (short-circuit current) flows via the electrically conductive foreign matter to cause generation of heat.
(2) In response to the generation of heat in (1), the negative electrode plate and the electrolyte solution react with each other to cause generation of heat.
(3) The positive electrode and the electrolyte solution react with each other to cause generation of heat.

Further, when the size of the battery is relatively large, the short-circuit current is increased, with the result that the heat of reaction between the positive electrode plate and the electrolyte solution tends to be likely to be generated.

In order to suppress the heat of reaction between the positive electrode plate and the electrolyte solution, it is required to improve melting/disconnection performance for interrupting the short-circuit current by melting a positive electrode substrate (metal foil or the like) to spread. As a time from occurrence of short circuit to occurrence of melting/disconnection is shorter, the melting/disconnection performance is more excellent. When a coating film is formed on a surface of the positive electrode active material by the electrolyte solution, the melting/disconnection property is likely to be improved but internal resistance of the battery is increased, with the result that its output characteristic tends to be likely to be decreased.

An object of the present disclosure is to provide: a non-aqueous electrolyte secondary battery in which internal resistance is suppressed from being increased and an excellent melting/disconnection property is attained; and a method of manufacturing the non-aqueous electrolyte secondary battery.

The present invention provides the following non-aqueous electrolyte secondary battery and the following method of manufacturing the non-aqueous electrolyte secondary battery.

[1] A non-aqueous electrolyte secondary battery comprising:
an electrode assembly; and
an electrolyte solution, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):
Li₍₁₊ₓ₎Ni_{y}Ti_{z}Me_{(1-y-z)}O₂, where
   Me includes two or more selected from a group consisting of Mn, Co and Al, and
   relations of 0<x<0.1, 0.8<y<0.85, and 0≤z<0.03 are satisfied,
the negative electrode active material layer includes a negative electrode active material, and
when a specific surface area of the negative electrode active material layer is represented by S, an average boron content of boron in the negative electrode active material layer is represented by M1 (mass %), and a boron content in a central portion of the negative electrode active material layer is represented by M2 (mass %), the following relational formulas are satisfied:
(a) M1/S≤0.1; and
(b) M2≥0.05.

[2] The non-aqueous electrolyte secondary battery according to [1], wherein
a total facing area in the electrode assembly is 3 m² or more, and
a length of a short side of a shape of the negative electrode active material layer that is one and continuous in the negative electrode plate when viewed in a plan view is 80 mm or more and 400 mm or less.

[3] The non-aqueous electrolyte secondary battery according to [1], wherein the following relational formula is further satisfied:
(c) 2≤S≤4.

[4] The non-aqueous electrolyte secondary battery according to [1], wherein a graphite content in the negative electrode active material is 99 mass % or more.

[5] A method of manufacturing a non-aqueous electrolyte secondary battery, the method comprising:
inserting an electrode assembly into an exterior package;
injecting an electrolyte solution; and
performing activation, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):
Li₍₁₊ₓ₎Ni_{y}Ti_{z}Me_{(1-y-z)}O₂, where
   Me includes two or more selected from a group consisting of Mn, Co and Al, and
   relations of 0<x<0.1, 0.8<y<0.85, and 0≤z<0.03 are satisfied,
the negative electrode active material layer includes a negative electrode active material, and
when a specific surface area of the negative electrode active material layer is represented by S, an average boron content of boron in the negative electrode active material layer is represented by M1 (mass %), and a boron content in a central portion of the negative electrode active material layer is represented by M2 (mass %), the following relational formulas are satisfied:
(a) M1/S≤0.1; and
(b) M2≥0.05.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary configuration of a battery according to the present embodiment.

FIG. 2 is a schematic diagram showing an exemplary configuration of an electrode assembly according to the present embodiment.

FIG. 3 is a schematic flowchart of a method of manufacturing the battery according to the present embodiment.

FIG. 4 is a schematic diagram showing a configuration of an electrode assembly according to an Example.

FIG. 5 is a schematic diagram for illustrating a portion in which a boron content is measured in the Example.

### DESCRIPTION OF THE PREFERRED EMBODIMENTS

Hereinafter, embodiments of the present invention will be described with reference to figures, but the present invention is not limited to the below-described embodiments. In each of all the figures described below, a scale is appropriately adjusted to facilitate understanding of each component, and the scale of each component shown in the figures does not necessarily coincide with the actual scale of the component. In the below-mentioned description of each of the embodiments, the same or corresponding portions are denoted by the same reference characters and will not be described repeatedly.

### <Non-Aqueous Electrolyte Secondary Battery>

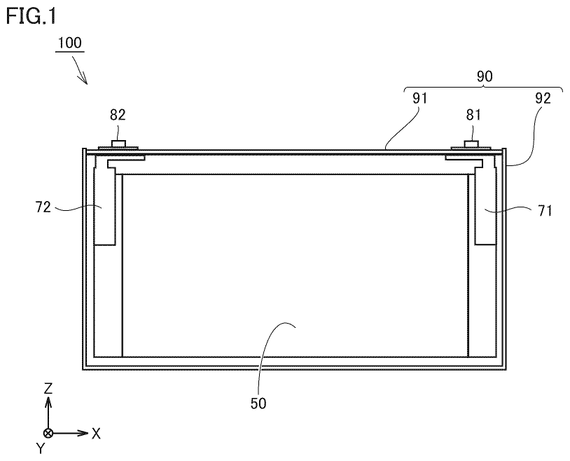

FIG. 1 is a schematic diagram showing an exemplary configuration of a battery according to the present embodiment.

A battery 100 may be used in any application. Battery 100 may be used as a main electric power supply or a motive power assisting electric power supply in an electrically powered vehicle or the like, for example. A battery module or a battery assembly may be formed by connecting a plurality of batteries 100.

Battery 100 includes an exterior package 90. Exterior package 90 has a prismatic shape (flat rectangular parallelepiped shape). It should be noted that the prismatic shape is exemplary. Exterior package 90 may have any shape. Exterior package 90 may have, for example, a cylindrical shape or a pouch shape. Exterior package 90 may be composed of, for example, an Al alloy. Exterior package 90 accommodates an electrode assembly 50 and an electrolyte solution (not shown). Exterior package 90 may include, for example, a sealing plate 91 and an exterior container 92. Sealing plate 91 closes an opening of exterior container 92. For example, sealing plate 91 and exterior container 92 may be joined to each other by laser welding.

A positive electrode terminal 81 and a negative electrode terminal 82 are provided on sealing plate 91. Sealing plate 91 may be further provided with an injection opening and a gas-discharge valve. The electrolyte solution can be injected from the injection opening to inside of exterior package 90. Electrode assembly 50 is connected to positive electrode terminal 81 by a positive electrode current collecting member 71. Positive electrode current collecting member 71 may be, for example, an Al plate or the like. Electrode assembly 50 is connected to negative electrode terminal 82 by a negative electrode current collecting member 72. Negative electrode current collecting member 72 may be, for example, a Cu plate or the like.

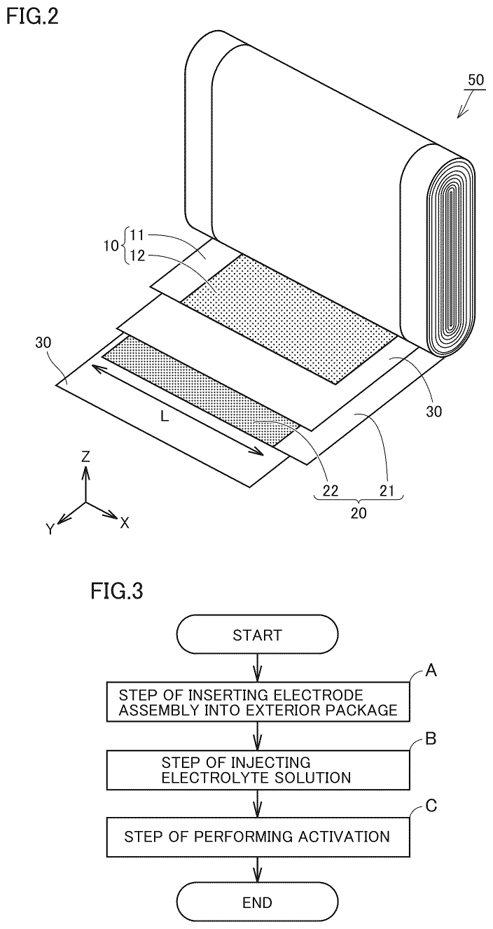

FIG. 2 is a schematic diagram showing an exemplary configuration of the electrode assembly according to the present embodiment. Electrode assembly 50 is a wound type. Electrode assembly 50 includes a positive electrode plate 10, a separator 30, and a negative electrode plate 20. That is, battery 100 includes positive electrode plate 10, negative electrode plate 20, and the electrolyte solution. Each of positive electrode plate 10, separator 30, and negative electrode plate 20 is a sheet in the form of a strip. Electrode assembly 50 may include a plurality of separators 30. Electrode assembly 50 is formed by stacking positive electrode plate 10, separator 30, and negative electrode plate 20 in this order and winding them in the form of a spiral. One of positive electrode plate 10 or negative electrode plate 20 may be interposed between separators 30. Each of positive electrode plate 10 and negative electrode plate 20 may be interposed between separators 30. Electrode assembly 50 may be shaped to have a flat shape after the winding. It should be noted that the wound type is exemplary. Electrode assembly 50 may be, for example, a stacked type.

A total facing area in electrode assembly 50 may be, for example, 3 m² or more. As shown in FIG. 2, in electrode assembly 50, positive electrode plate 10 and negative electrode plate 20 are stacked on each other with separator 30 being interposed therebetween, thereby forming portion(s) of positive electrode plate 10 facing negative electrode plate 20 and located on one side or both sides thereof and forming portion(s) of negative electrode plate 20 facing positive electrode plate 10 and located on one side or both sides thereof. The total facing area in electrode assembly 50 refers to a sum of the area of the portion(s) of positive electrode plate 10 facing negative electrode plate 20 and the area of the portion(s) of negative electrode plate 20 facing positive electrode plate 10. The total facing area in electrode assembly 50 may be, for example, 3 m² or more and 10 m² or less.

### (Positive Electrode Plate)

Positive electrode plate 10 includes a positive electrode substrate 11 and a positive electrode active material layer 12. Positive electrode substrate 11 is an electrically conductive sheet. Positive electrode substrate 11 may be, for example, an Al alloy foil or the like. Positive electrode substrate 11 may have a thickness of, for example, 10 μm to 30 μm. Positive electrode active material layer 12 is disposed on a surface of positive electrode substrate 11. Positive electrode active material layer 12 may be disposed only on one surface of positive electrode substrate 11, for example. Positive electrode active material layer 12 may be disposed on each of the front and rear surfaces of positive electrode substrate 11, for example. Positive electrode substrate 11 may be exposed at one end portion in the width direction of positive electrode plate 10 (X axis direction in FIG. 2). Positive electrode current collecting member 71 can be joined to the exposed portion of positive electrode substrate 11.

For example, an intermediate layer (not shown) may be formed between positive electrode active material layer 12 and positive electrode substrate 11. In the present embodiment, also when the intermediate layer is present, positive electrode active material layer 12 is regarded as being disposed on the surface of positive electrode substrate 11. The intermediate layer may be thinner than positive electrode active material layer 12. The intermediate layer may have a thickness of 0.1 μm to 10 μm, for example. The intermediate layer may include, for example, a conductive material, an insulating material, or the like.

### (Positive Electrode Active Material Layer)

Positive electrode active material layer 12 includes a positive electrode active material. The positive electrode active material includes a lamellar metal oxide represented by the following formula (1):
Li₍₁₊ₓ₎Ni_{y}Ti_{z}Me_{(1-y-z)}O₂, where
   Me includes two or more selected from a group consisting of Mn, Co and Al, and
   relations of 0<x<0.1, 0.8<y<0.85, and 0≤z<0.03 are satisfied.

From the viewpoint of the melting/disconnection property, the lamellar metal oxide represented by the formula (1) preferably satisfies relations of 0<x<0.2, 0.8<y<0.84, and 0.01<z<0.03.

The lamellar metal oxide represented by the formula (1) may include at least one selected from a group consisting of Zr, B, Mg, Fe, Cu, Zn, Sn, Na, K, Ba, Sr, Ca, W, Mo, Nb, Si, V, Cr, and Ge.

The positive electrode active material is a particle group. The particle group can include a first positive electrode active material particle group and a second positive electrode active material particle group. The first positive electrode active material particle group consists of a plurality of first positive electrode active material particles. The second positive electrode active material particle group consists of a plurality of second positive electrode active material particles. Each of the first positive electrode active material particles and the second positive electrode active material particles can have any shape. Each of the first positive electrode active material particle and the second positive electrode active material particle may have a spherical shape, a columnar shape, a lump-like shape, or the like, for example.

The plurality of first positive electrode active material particles may have an average particle size (D50) of, for example, 10 μm to 20 μm. The plurality of second positive electrode active material particles may have an average particle size (D50) of, for example, 0.5 μm to 9 μm. In the present specification, the average particle size (D50) is defined as a particle size corresponding to a cumulative frequency of 50% from the smallest particle size in a volume-based particle size distribution. The volume-based particle size distribution can be measured by a laser diffraction type particle size distribution measurement apparatus.

Each of the first positive electrode active material particles and the second positive electrode active material particles independently includes the positive electrode active material represented by the formula (1). Each of the first positive electrode active material particle and the second positive electrode active material particle can independently have any crystal structure. Each of the first positive electrode active material particle and the second positive electrode active material particle may independently have a lamellar structure, a spinel structure, an olivine structure, or the like, for example. Each of the first positive electrode active material particle and the second positive electrode active material particle may have substantially the same chemical composition. The first positive electrode active material particle and the second positive electrode active material particle may have chemical compositions different from each other.

Positive electrode active material layer 12 may further include an additional component as long as the positive electrode active material is included. Positive electrode active material layer 12 may include, for example, a conductive material, a binder, or the like in addition to the positive electrode active material. The conductive material can include any component. For example, the conductive material may include at least one selected from a group consisting of carbon black, graphite, vapor-grown carbon fiber (VGCF), carbon nanotube (CNT), and graphene flake. A blending amount of the conductive material may be, for example, 0.1 part by mass to 10 parts by mass with respect to 100 parts by mass of the positive electrode active material. The binder can include any component. For example, the binder may include at least one selected from a group consisting of polyvinylidene difluoride (PVdF), poly(vinylidene fluoride-co-hexafluoropropylene) (PVdF-HFP), polytetrafluoroethylene (PTFE), and polyacrylic acid (PAA). A blending amount of the binder may be, for example, 0.1 part by mass to 10 parts by mass with respect to 100 parts by mass of the positive electrode active material. Positive electrode active material layer 12 may include 80% to 99% of the positive electrode active material in mass fraction, 0.1% to 10% of the conductive material in mass fraction, and a remainder of the binder, for example.

Positive electrode active material layer 12 may have a thickness of, for example, 10 μm to 200 μm. Positive electrode active material layer 12 may have a thickness of, for example, 50 μm to 150 μm. Positive electrode active material layer 12 may have a thickness of, for example, 50 μm to 100 μm.

Positive electrode active material layer 12 can have a high density. Positive electrode active material layer 12 may have a density of 3.3 g/cm³ to 3.9 g/cm³, for example. Positive electrode active material layer 12 may have a density of 3.4 g/cm³ to 3.7 g/cm³, for example. Positive electrode active material layer 12 may have a density of 3.4 g/cm³ to 3.6 g/cm³, for example. The density of the active material layer in the present specification represents an apparent density.

Positive electrode plate 10 is manufactured in the following manner: positive electrode active material layer 12 is formed by applying a positive electrode slurry to a surface of positive electrode substrate 11, positive electrode active material layer 12 and positive electrode substrate 11 are subjected to rolling to manufacture a raw sheet, and then the raw sheet is cut into a predetermined planar size in accordance with the specification of battery 100. The positive electrode slurry is prepared by mixing the positive electrode active material and the additional component.

### (Negative Electrode Plate)

Negative electrode plate 20 may include a negative electrode substrate 21 and a negative electrode active material layer 22, for example. Negative electrode substrate 21 is an electrically conductive sheet. Negative electrode substrate 21 may be, for example, a Cu alloy foil or the like. Negative electrode substrate 21 may have a thickness of, for example, 5 μm to 30 μm. Negative electrode active material layer 22 may be disposed on a surface of negative electrode substrate 21. Negative electrode active material layer 22 may be disposed only on one surface of negative electrode substrate 21, for example. Negative electrode active material layer 22 may be disposed on each of the front and rear surfaces of negative electrode substrate 21, for example. Negative electrode substrate 21 may be exposed at one end portion in the width direction of negative electrode plate 20 (X axis direction in FIG. 2). Negative electrode current collecting member 72 can be joined to the exposed portion of negative electrode substrate 21.

### (Negative Electrode Active Material Layer)

Negative electrode active material layer 22 includes a negative electrode active material. The negative electrode active material may include any component. The negative electrode active material may include, for example, at least one selected from a group consisting of graphite, soft carbon, hard carbon, silicon, silicon oxide, a silicon-based alloy, tin, tin oxide, a tin-based alloy, and lithium-titanium composite oxide. The graphite may be natural graphite or may be artificial graphite.

Negative electrode active material layer 22 further includes boron (B). When a specific surface area of negative electrode active material layer 22 is represented by S, an average boron content of boron in negative electrode active material layer 22 is represented by M1 (mass %), and a boron content in the central portion of negative electrode active material layer 22 is represented by M2 (mass %), the following relational formulas are satisfied:
(a) M1/S≤0.1
(b) M2≥0.05.
   The central portion is a central portion in the plane of the negative electrode plate when the negative electrode plate is viewed in a plan-view direction.

When electrode assembly 50 is viewed in the direction of the plane of the electrode plate, the electrolyte solution tends to be less likely to permeate the central portion in the plane of the electrode plate. For example, since the electrolyte solution is injected from a surface of the battery having a prismatic shape other than surfaces thereof in the direction of the plane of the electrode plate included in the electrode assembly (any surface of the four short side surfaces; generally, the injection hole on the cover side), the electrolyte solution tends to be less likely to permeate the central portion of the electrode plate in the plane of the electrode plate. As a result, an amount of a coating film formed by the electrolyte solution on the surface of the active material becomes small, with the result that the melting/disconnection property tends to be likely to be decreased. Further, when the amount of the coating film in the central portion of electrode assembly 50 is increased, the amount of the coating film becomes excessively large, with the result that the internal resistance of the battery tends to be likely to be increased. However, by satisfying the relational formulas (a) and (b), it is possible to provide a battery in which the resistance and the melting/disconnection property are balanced. The central portion of the negative electrode plate can be a region having a radius of 20 mm from the center of the plane of the negative electrode plate when electrode assembly 50 is viewed in the Y axis direction.

The relational formulas (a) and (b) are satisfied by, for example, the following method: selection of a type of an additive included in the electrolyte solution and adjustment of a concentration thereof; adjustment of specific surface area, thickness and density of negative electrode active material layer 22; selection of a type of the negative electrode active material and adjustment of a content thereof; or the like. Battery 100 can satisfy the relational formulas (a) and (b) after a below-described step of performing activation.

M1 may be, for example, 0.1 to 0.5 mass %, and is preferably 0.15 to 3 mass %.

M2 may be, for example, 0.05 to 0.3 mass %, and is preferably 0.09 to 0.2 mass %. Each of M1 and M2 is measured in accordance with a method described in the below-described section of Examples. In the case of the wound type electrode assembly, M2 may be a boron content in the central portion of the negative electrode active material layer at its portion serving as an outermost layer. In the case of the wound type electrode assembly, M1 may be an average value of boron contents at nine locations in the plane of the negative electrode active material layer at its portion serving as the outermost layer. On the other hand, in the case of the stacked type electrode assembly, M2 may be a boron content in the central portion of the outermost negative electrode active material layer. In the case of the stacked type electrode assembly, M1 may be an average value of boron contents at nine locations in the plane of the outermost negative electrode active material layer.

Negative electrode active material layer 22 further satisfies the following relational formula:
(c) 2≤S≤4.
   Specific surface area S of negative electrode active material layer 22 is measured in accordance with a method described in the below-described section of Examples.

Negative electrode active material layer 22 may further include, for example, a binder or the like as the other component in addition to the negative electrode active material. For example, negative electrode active material layer 22 may include: 95% to 99.5% of the negative electrode active material in mass fraction; and the remainder of the binder. The binder can include any component. The binder may include, for example, at least one selected from a group consisting of carboxymethyl cellulose (CMC) and styrene-butadiene rubber (SBR). When negative electrode active material layer 22 includes graphite, a graphite content in the negative electrode active material is preferably 99 mass % or more. The specific surface area of the negative electrode active material may be, for example, 0.5 to 5 m²/g.

Negative electrode active material layer 22 may have a thickness of, for example, 10 μm to 200 μm.

Negative electrode active material layer 22 can have a high density. Negative electrode active material layer 22 may have a density of, for example, 1.0 g/cm³ to 2.0 g/cm³. Negative electrode active material layer 22 may have a density of, for example, 1.2 g/cm³ to 1.7 g/cm³. Negative electrode active material layer 22 may have a density of, for example, 1.3 g/cm³ to 1.6 g/cm³.

Negative electrode plate 20 is manufactured in the following manner: negative electrode active material layer 22 is formed by applying a negative electrode slurry to a surface of negative electrode substrate 21, negative electrode active material layer 22 and negative electrode substrate 21 are subjected to rolling to manufacture an raw sheet, and then the raw sheet is cut into a predetermined planar size in accordance with the specification of battery 100. The negative electrode slurry is prepared by mixing the negative electrode active material and the other component.

A shape of the negative electrode active material layer that is one and continuous in negative electrode plate 20 when viewed in a plan view may be, for example, a rectangular shape. A length (length L in FIG. 2) of the short side of the shape of the negative electrode active material layer that is one and continuous in negative electrode plate 20 when viewed in a plan view may be, for example, 80 mm or more and 400 mm or less.

### (Separator)

At least a portion of separator 30 is interposed between positive electrode plate 10 and negative electrode plate 20. Separator 30 separates positive electrode plate 10 and negative electrode plate 20 from each other. Separator 30 may have a thickness of, for example, 10 μm to 30 μm.

Separator 30 is a porous sheet. Separator 30 permits the electrolyte solution to pass therethrough. Separator 30 may have an air permeability of, for example, 100 s/100 mL to 400 s/100 mL. In the present specification, the “air permeability” represents “Air Resistance” defined in “JIS P 8117: 2009”. The air permeability is measured by the Gurley test method.

Separator 30 is electrically insulative. Separator 30 may include, for example, a polyolefin-based resin or the like. Separator 30 may consist essentially of a polyolefin-based resin, for example. The polyolefin-based resin may include at least one selected from a group consisting of polyethylene (PE) and polypropylene (PP), for example. Separator 30 may have a single-layer structure, for example. Separator 30 may consist essentially of a PE layer, for example. Separator 30 may have a multilayer structure, for example. Separator 30 may be formed by stacking a PP layer, a PE layer, and a PP layer in this order, for example. A heat-resistant layer or the like may be formed on the surface of separator 30, for example.

### (Electrolyte Solution)

The electrolyte solution includes a solvent and a supporting electrolyte. The solvent is aprotic. The solvent can include any component. The solvent may include, for example, at least one selected from a group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. For example, the supporting electrolyte may include at least one selected from a group consisting of LiPF₆, LiBF₄, and LiN(FSO₂)₂. The supporting electrolyte may have a molar concentration of, for example, 0.5 mol/L to 2.0 mol/L. The supporting electrolyte may have a molar concentration of, for example, 0.8 mol/L to 1.2 mol/L.

The electrolyte solution may further include any additive. For example, the electrolyte solution may include the additive having a mass fraction of 0.01% to 5%. The additive may include, for example, at least one selected from a group consisting of vinylene carbonate (VC), lithium difluorophosphate (LiPO₂F₂), lithium fluorosulfonate (FSO₃Li), and lithium bis(oxalato)borate (LiBOB). The electrolyte solution preferably includes LiBOB. When the electrolyte solution includes LiBOB, the content of LiBOB in the electrolyte solution may be, for example, 0.1 to 1.5 mass %.

### <Method of Manufacturing Battery>

As shown in FIG. 3, a method of manufacturing the battery according to the present embodiment includes: a step (A) of inserting the electrode assembly into the exterior package; a step (B) of injecting the electrolyte solution; and a step (C) of performing activation.

In the step (A) of inserting the electrode assembly into the exterior package, electrode assembly 50 is accommodated in exterior package 90. Electrode assembly 50 can be connected to positive electrode terminal 81 by positive electrode current collecting member 71. Electrode assembly 50 can be connected to negative electrode terminal 82 by, for example, negative electrode current collecting member 72.

In the step (B) of injecting the electrolyte solution, the electrolyte solution is injected into exterior package 90. Electrode assembly 50 is impregnated with the electrolyte solution. After the electrolyte solution is injected, exterior package 90 is sealed.

In the step (C) of performing activation, battery 100 is activated. For example, battery 100 is charged in accordance with a constant current-constant voltage (CC-CV) method, and is discharged in accordance with a constant current (CC) method after passage of a predetermined time. More specifically, under a temperature environment of 25° C., charging is performed with a current of 0.2 mA/cm² in accordance with the constant current method until the positive electrode potential reaches 4.30 V (vs. Li⁺/Li), and then charging is performed in accordance with the constant voltage method until the current reaches 0.04 mA/cm². After 10 minutes of rest, discharging is performed with a current of 0.2 mA/cm² in accordance with the constant current method until the positive electrode potential reaches 2.5 V (vs. Li⁺/Li).

In this way, battery 100 is manufactured. Since battery 100 thus manufactured satisfies the relational formulas (a) and (b) as described above, the internal resistance is suppressed from being increased and an excellent melting/disconnection property is attained therein.

### EXAMPLES

Hereinafter, the present invention will be described in more detail with reference to examples. “%” and “parts” in the examples are mass % and parts by mass unless otherwise stated particularly.

### Example 1

### (Manufacturing of Positive Electrode Plate)

Large particles and small particles both composed of a lithium-nickel composite oxide (Li_{1.03}Ni_{0.82}Co_{0.05}Mn_{0.11}O₂) were mixed to prepare a mixed powder of a positive electrode active material. A mixing ratio was “large particles/small particles=6/4 (mass ratio)”. D50 of the large particles was 17 μm, and D50 of the small particles was 4 μm. A positive electrode slurry was prepared by mixing 97.6 parts by mass of the mixed powder, 1.5 parts by mass of a conductive material (carbon black), 0.9 parts by mass of a binder (PVdF), and a predetermined amount of a dispersion medium (N-methyl-2-pyrrolidone). The positive electrode slurry was applied to a surface of a positive electrode substrate (Al foil) at a coating amount of 350 (g/m²) and was dried to form a positive electrode active material layer. The positive electrode active material layer was compressed by a rolling machine. In this way, a positive electrode raw sheet in which the density of the positive electrode active material layer is 3.5 (g/cc) was manufactured. The positive electrode raw sheet was cut into a predetermined size, thereby manufacturing a positive electrode plate. A tab terminal (Al thin plate) was joined to the positive electrode plate.

### (Manufacturing of Negative Electrode Plate)

A negative electrode slurry was prepared by mixing 98 parts by mass of a negative electrode active material (graphite; D50=17 μm and specific surface area=1.2 m²/g), 1 part by mass of CMC, 1 part by mass of SBR, and a predetermined amount of a dispersion medium (water). The negative electrode slurry was applied to a surface of the negative electrode substrate (Cu foil) at a coating amount of 225 (g/m²) and was dried to form a negative electrode active material layer having a specific surface area S of 2 (m²/g). The negative electrode active material layer was compressed by a rolling machine. In this way, a negative electrode raw sheet in which the density of the negative electrode active material layer is 1.5 (g/cc) was manufactured. The negative electrode raw sheet was cut into a predetermined size, thereby manufacturing a negative electrode plate. A tab terminal (Ni thin plate) was joined to the negative electrode plate.

### (Assembly)

A porous sheet composed of polyolefin was prepared as a separator. The positive electrode plate, the separator, and the negative electrode plate were stacked with the separator being interposed between the positive electrode plate and the negative electrode plate. By winding them, a wound type electrode assembly was formed. As an exterior package, a pouch composed of an Al laminate film was prepared. The electrode assembly was accommodated in the exterior package.

### (Injection of Electrolyte Solution)

An electrolyte solution was prepared. The electrolyte solution included below-described components. The electrolyte solution was injected into the exterior package at an amount of 2 (g/Ah). The exterior package was sealed. In this way, a test cell was manufactured.
Solvent: EC/EMC=3/7 (volume ratio)
Supporting electrolyte: LiPF₆ (1 mol/L)
Additive: LiBOB (0.5% in mass fraction)

### (Activation)

Initial charging/discharging was performed under a temperature environment of 25° C. The test cell was charged with a current of 0.2 mA/cm² in accordance with the constant current method until the positive electrode potential reached 4.30 V (vs. Li⁺/Li). Then, the test cell was charged in accordance with the constant voltage method until the current reached 0.04 mA/cm². After 10 minute of rest, the test cell was discharged with a current of 0.2 mA/cm² in accordance with the constant current method until the positive electrode potential reached 2.5 V (vs. Li⁺/Li). In the present example, in each of all the test cells, the positive electrode had an initial single-electrode charging capacity of 80 Ah/m² and the negative electrode had an initial single-electrode charging capacity of 85 Ah/m², and the positive electrode had an initial single-electrode discharging capacity of 73.6 Ah/m² and the negative electrode had an initial single-electrode discharging capacity of 78.2 Ah/m². It should be noted that the current [mA/cm²] in the present example is normalized by the area of the positive electrode plate.

Each of the test cells produced as described above was evaluated as follows. Results are shown in Table 1.

### (Internal Resistance)

Under a temperature environment of 25° C., the SOC (State of Charge) of the test cell was adjusted to 50% by the constant current-constant voltage (CC-CV) charging (CC current=⅓ C, CV voltage =3.7 V, 1/20 C cutoff). Then, the temperature thereof was adjusted by holding it at a temperature of −30° C. for 5 hours or more. Discharging was performed for 10 seconds at each of current values of 0.1 C, 0.2 C, 0.3 C, 0.4 C, 0.5 C, and 0.6 C, and a voltage was measured. After the voltage measurement at each current value, charging was performed at 0.05 C in accordance with the discharging capacity to suppress a change in SOC, and rest of 30 minutes is provided. Resistance was calculated from an I-V plot by linear approximation. In the present example, the internal resistance of Comparative Example 1 is defined as 100. When the internal resistance is 120 or less, it is considered that the output characteristic is excellent.

### (Boron Content)

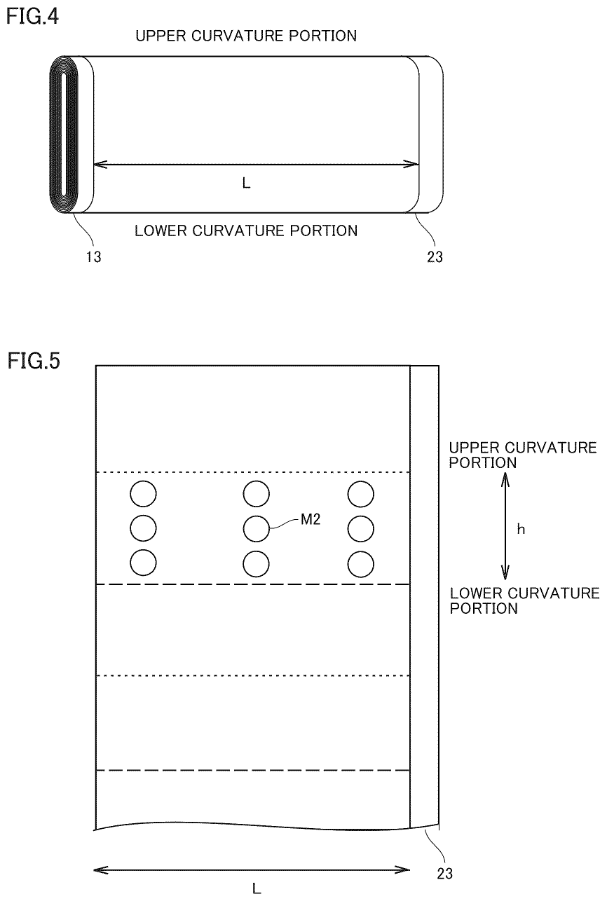

The test cell was charged (0.05 C, 4.2 V cutoff), was discharged (0.05 C, 3.0 V cutoff), and was then disassembled. As shown in FIG. 4, a wound type electrode assembly was removed which included tabs 13, 23, which had a length L in the width direction of the active material layer, and which had an upper curvature portion (curved portion on the upper side of the wound body) and a lower curvature portion (curved portion on the lower side of the wound body). Tab 13 is a portion (substrate) of the positive electrode plate at which the positive electrode active material layer is not formed, and tab 23 is a portion (substrate) of the negative electrode plate at which the positive electrode active material layer is not formed. As shown in FIG. 5, a region M2 in the central portion was cut out from a portion of the removed negative electrode plate corresponding to the outermost layer of the negative electrode plate. Thereafter, the negative electrode active material was detached in 10 ml of water, thereby collecting a sample for boron content measurement. The center of region M2 in the central portion was a region having a radius of 20 mm and centered at a midpoint of each of L and h. L represents the length of the short side of the negative electrode active material layer, and h represents a distance between the apex of the upper curvature portion and the apex of the lower curvature portion of the electrode assembly in the negative electrode active material layer. 10 mL of hydrochloric acid was added to the water including the boron content measurement sample, and heat treatment was performed at a temperature of 80° C. for 30 minutes. The obtained aqueous solution was filtered using filter paper, water was added to a deposited object on the filter paper, an adhered object on the filter paper was also collected, B-ICP measurement was then performed with the volume of the collected aqueous solution being 100 mL, and a boron content M2 (mass %) in the central portion of the negative electrode active material layer was found in accordance with an external calibration curve method.

Next, as with region M2 of the central portion, the boron content was measured in each of remaining eight regions other than M2 and circled as shown in FIG. 4, and an average value of the boron contents found from the nine regions including the eight regions and region M2 was defined as average boron content M1 (mass %) of boron in the negative electrode active material layer.

### (Specific Surface Area)

A BET specific surface area of the negative electrode plate removed from the electrode assembly disassembled in the measurement of the boron content was measured in accordance with a nitrogen adsorption method.

### (Nail Penetration Test)

The test cell was charged. The test battery was connected to a data logger. The data logger has a voltage measurement function and a current measurement function. A nail (manufactured by DAIDOHANT; a circular nail with a body diameter=3 mm) was prepared. The test battery was penetrated by the nail. When voltage drop was confirmed, the penetration by the nail was halted. After the halt of the nail, voltage and current were measured until voltage increase was detected. It is considered that the voltage drop indicates occurrence of a short circuit. It is considered that the voltage increase after the voltage drop indicates that the positive electrode substrate (Al foil) around the nail is melted by Joule heat resulting from the short circuit and is spread to interrupt the current. An amount of generated heat was calculated in accordance with the voltage, current, and time until the voltage increase was detected. It is considered that as the amount of generated heat is smaller, the melting/disconnection performance is more excellent. In Table 1, O represents a case where the amount of generated heat is less than 35 W, whereas X represents a case where the amount of generated heat is 35 W or more.

### Examples 2 and 3 and Comparative Examples 1 to 5

As shown in Table 1, each of test cells was manufactured in the same manner as in Example 1 except that the composition ratio of the positive electrode active material, the type and specific surface area of the negative electrode active material, the specific surface area of the negative electrode active material layer, the content of LiBOB in the electrolyte solution, and the boron content were changed. Results are shown in Table 1.

TABLE 1

| | | | | | Comparative | Comparative | Comparative | Comparative | Comparative |
|---|---|---|---|---|---|---|---|---|---|
| | | Example 1 | Example 2 | Example 3 | Example 1 | Example 2 | Example 3 | Example 4 | Example 5 |
| Composition | Li/(Ni + Co + | 1.03 | 1.03 | 1.03 | 1.03 | 1.03 | 1.03 | 1.03 | 1.03 |
| Ratio of | Mn + Ti) | | | | | | | | |
| Positive | Ni | 0.82 | 0.82 | 0.82 | 0.82 | 0.82 | 0.82 | 0.82 | 0.82 |
| Electrode | Co | 0.05 | 0.05 | 0.05 | 0.05 | 0.05 | 0.05 | 0.05 | 0.05 |
| Active | Mn | 0.11 | 0.11 | 0.11 | 0.11 | 0.11 | 0.11 | 0.11 | 0.11 |
| Material | Ti | 0.02 | 0.02 | 0.02 | 0.02 | 0.02 | 0.02 | 0.02 | 0.02 |
| Negative | Type | Artificial | Natural | Natural | Artificial | Artificial | Artificial | Natural | Natural |
| Electrode | | Graphite | Graphite | Graphite | Graphite | Graphite | Graphite | Graphite | Graphite |
| Active | Specific | 1.2 | 2.9 | 2.9 | 1.2 | 1.2 | 1.2 | 2.9 | 2.9 |
| Material | Surface | | | | | | | | |
| | Area | | | | | | | | |
| | (m²/g) | | | | | | | | |
| Negative | Specific | 2 | 4 | 4 | 2 | 2 | 2 | 4 | 4 |
| Electrode | Surface | | | | | | | | |
| Active | Area S | | | | | | | | |
| Material | (m²/g) | | | | | | | | |
| Layer | | | | | | | | | |
| Electrolyte | LiBOB | 0.5 | 0.5 | 1 | 0.15 | 0.25 | 1 | 0.15 | 0.25 |
| Solution | Content | | | | | | | | |
| | (Mass %) | | | | | | | | |
| Boron | M1 (Mass %) | 0.15 | 0.15 | 0.3 | 0.045 | 0.075 | 0.3 | 0.045 | 0.075 |
| Content | M2 (Mass %) | 0.09 | 0.09 | 0.2 | 0.015 | 0.04 | 0.2 | 0.02 | 0.04 |

| | | | | | | | | |
|---|---|---|---|---|---|---|---|---|
| M1/S | 0.08 | 0.04 | 0.08 | 0.02 | 0.04 | 0.15 | 0.01 | 0.02 |
| Cell Capacity (Ah/m²) | 73.6 | 72 | 72 | 73.6 | 73.6 | 73.6 | 72 | 72 |
| Resistance | 120 | 100 | 120 | 100 | 110 | 150 | 90 | 95 |
| Nail Penetration Test | ◯ | ◯ | ◯ | X | X | ◯ | X | X |

In each of Examples 1 to 3, the resistance was suppressed from being increased and an excellent result was obtained in the nail penetration test.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A non-aqueous electrolyte secondary battery comprising:
an electrode assembly; and
an electrolyte solution, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):
Li₍₁₊ₓ₎Ni_{y}Ti_{z}Me_{(1-y-z)}O₂, where
Me includes two or more selected from a group consisting of Mn, Co and Al, and
relations of 0<x<0.1, 0.8<y<0.85, and 0≤z<0.03 are satisfied,
the negative electrode active material layer includes a negative electrode active material, and
when a specific surface area of the negative electrode active material layer is represented by S, an average boron content of boron in the negative electrode active material layer is represented by M1 (mass %), and a boron content in a central portion of the negative electrode active material layer is represented by M2 (mass %), the following relational formulas are satisfied:
(a) M1/S≤0.1; and
(b) M2≥0.05.

2. The non-aqueous electrolyte secondary battery according to claim 1, wherein
a total facing area in the electrode assembly is 3 m² or more, and
a length of a short side of a shape of the negative electrode active material layer that is one and continuous in the negative electrode plate when viewed in a plan view is 80 mm or more and 400 mm or less.

3. The non-aqueous electrolyte secondary battery according to claim 1, wherein the following relational formula is further satisfied:
(c) 2≤S≤4.

4. The non-aqueous electrolyte secondary battery according to claim 1, wherein a graphite content in the negative electrode active material is 99 mass % or more.

5. A method of manufacturing a non-aqueous electrolyte secondary battery, the method comprising:
inserting an electrode assembly into an exterior package;
injecting an electrolyte solution; and
performing activation, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):
Li₍₁₊ₓ₎Ni_{y}Ti_{z}Me_{(1-y-z)}O₂, where
Me includes two or more selected from a group consisting of Mn, Co and Al, and
relations of 0<x<0.1, 0.8<y<0.85, and 0≤z<0.03 are satisfied,
the negative electrode active material layer includes a negative electrode active material, and
when a specific surface area of the negative electrode active material layer is represented by S, an average boron content of boron in the negative electrode active material layer is represented by M1 (mass %), and a boron content in a central portion of the negative electrode active material layer is represented by M2 (mass %), the following relational formulas are satisfied:
(a) M1/S≤0.1; and
(b) M2≥0.05.
